(19) United States
(12) Patent Application Publication
(10) Pub. No.: US 2017/0069411 A1
(43) Pub. Date: Mar. 9, 2017

(54) Method of Manufacturing a Cable

(71) Applicant: NEXANS, PARIS (FR)

(72) Inventors: Daniel HALLER, Lauf (DE); Encarnacion GONZALEZ CALVO, Schwabach (DE)

(21) Appl. No.: 15/260,600

(22) Filed: Sep. 9, 2016

(30) Foreign Application Priority Data
Sep. 9, 2015 (EP) 15 306 375.5

(51) Int. Cl. H01B 13/14; G02B 6/44

(52) U.S. Cl. CPC H01B 13/141; G02B 6/4482; G02B 6/4483

(57) ABSTRACT

A method of manufacturing a cable with an electrical and/or optical transmission element containing core, which is surrounded by a cover of insulation material is indicated. Generated on the outer side of the cable on its entire length is at least one in the axial direction running strip composed of insulation material, which has a different color than the cover has. The material of the cover and the strip are applied by means of an extruder through co-extrusion simultaneously on the core of the cable so that the material of the strips is integrated into the material of the cover. The material of the cover and strips are applied by means of an extruder which has an inner flow channel and one surrounding all-around outer flow channel which merge. In the outer flow channel is arranged an all-around existing barrier constructed as a ring, that has at least one passage for the required material for a strip. The material of the strips is with pressure forced through the passage and pushed or pressed in the inner flow channel, through which the material for the cover is guided, as a result of which the material of the strips is imprinted or pressed into the material of the cover and thereby is tightly bound with the same or anchored in the same.

### RELATED APPLICATION

This application claims the benefit of priority from European Patent Application No. 15 306 375.5, filed on Sep. 9, 2015, the entirety of which is incorporated by reference.

### BACKGROUND

Field of the Invention

The invention relates to a method of manufacturing a cable with an electrical and/or optical transmission element containing core, which is surrounded by a cover of insulation material with which generated on the outer side of the cable on its entire length is at least one in the axial direction running strip composed of insulation material, which has a different color than the cover has, and with which the material of the cover and the strip are applied by means of an extruder through co-extrusion simultaneously on the core of the cable so that the material of the strips is integrated into the material of the covers.

Discussion of Prior Art

Such a method of manufacturing cable in varying embodiments has been known for many years and is commercially available. Such cable provided with design features through which they are easily identifiable is also known. So-called tracer threads can be provided in the core of the cable with which the manufacturer can associate with the cable. It is also known that specifications of the cable type are printed on the cover of the cable by the manufacturer and is recognizable from the outside. Moreover, cables with covers can be recognized that consist of at least two different colors against each other delimited in the circumferential direction.

DE 10 2008 063 B4 shows a grounding cable in its cable cover which has on the outer side two individual lying opposite each other line formed markings incorporated on or in the cable cover which have, for example, a blue color. The way these markings are fixed on or in the cable cover is not explained.

### Objects and Summary

The invention is based on the object that the previously described method is so structured that a permanent secure identification of the cables, manufactured with this method, is ensured.

The object of the invention is met in
that the material of the cover and strips is applied by means of an extruder, having an inner flow channel and one same surrounding all-around flow channel, which merge,
that in the outer flow channel is arranged an all-around existing barrier constructed as a ring, that has at least one passage for the required material for a strip in the outer flow channel, and
that the material of the strips is with pressure forced through the passage and pushed or pressed in the inner flow channel, through which the material for the cover is guided, as a result of which the material of the strips is imprinted or pressed into the material of the cover and thereby is tightly bound with the same or anchored in the same.

This cable manufactured with this method has at least one strip on the upper surface running in the axial direction on its entire length, which lifts off the color from the material of the cover and is anchored tightly in the material of the same. The strip is produced at the same time as the cover in co-extrusion technology and is imprinted in the radial direction in the material of the cover. It is ensured that during its lifetime the cable will be identified by the strip provided. During the manufacture of the cable, a material is used for the strip that by the use of heat and pressure is tightly bound with the material of the cover. Since both materials are flowable, as a rule, they are able to be contained in the same heat. The tight bonding of both materials is then especially easily achievable when the same material is used for the cover and strips, that for the cover on one hand and the strips on the other hand they only be differently colored. Such a material for example is polyvinyl chloride (PVC).

For the manufacture of the cable an extruder is used, with which two layers lying over one another in co-extrusion can be formed around a cable core. Such an extruder may be referred to as “skin-extruder” in this field. It has two separate next to each other flow channels, an inner flow channel and an outer flow channel, which change into a common flow channel before contact on the core of the cable. To produce a strip through the inner flow channel in a required material of the cover, the outer flow channel is closed by an all-around existing barrier that only has one passage for the material provided for the strips. The material of the strips is with high pressure pressed through a single narrow area representing a passage, so that it impinges in the radial direction on the material of the cover and in the same is pushed or pressed. The material of the strips binds itself as a result tightly with the material of the cover. The depth with which the material of the strips penetrates into the material of the cover depends on the amount of pressure applied.

If two or more strips in the circumferential direction offset relative to each other should be produced, then there would be a corresponding number of passages provided in the barrier of the outer flow channel.

Embodiments of the subject matter of the invention are illustrated in the drawings.

### BRIEF DESCRIPTION OF THE DRAWINGS

FIG. 1 is a top view of a portion of a section of the cable with a continuous strip manufactured with the method according to the invention.

FIG. 2 shows a sectional view of FIG. 1 along the lines II-II.

FIG. 3 shows opposite FIG. 2 a modified embodiment of the cable also in a sectional view.

FIG. 4 schematically shows a cross sectional view of an extruder.

FIG. 5 shows an enlarged illustration of a detail of the extruder according to FIG. 4 in an enlarged illustration.

FIGS. 6 and 7 show two views of a further detail of the extruder according to FIG. 4, also in an enlarged illustration.

FIG. 8 shows a sectional view through an extruder according to FIG. 4 in the area of the mounted barrier.

### DETAILED DESCRIPTION

FIG. 1 shows a section of a cable 1 with a randomly constructed core 2 in which can also be contained electrical and/or optical transmission elements. The core 2 is surrounded by a cover 3 composed of insulation material which for example consists of PVC. The cover 3 has a cable 1 extending in the longitudinal direction along the entire length of the same existing strip 4 which is bound tightly with the material of the cover 3. It is also composed of, for example, PVC and has a different color compared to the cover 3.

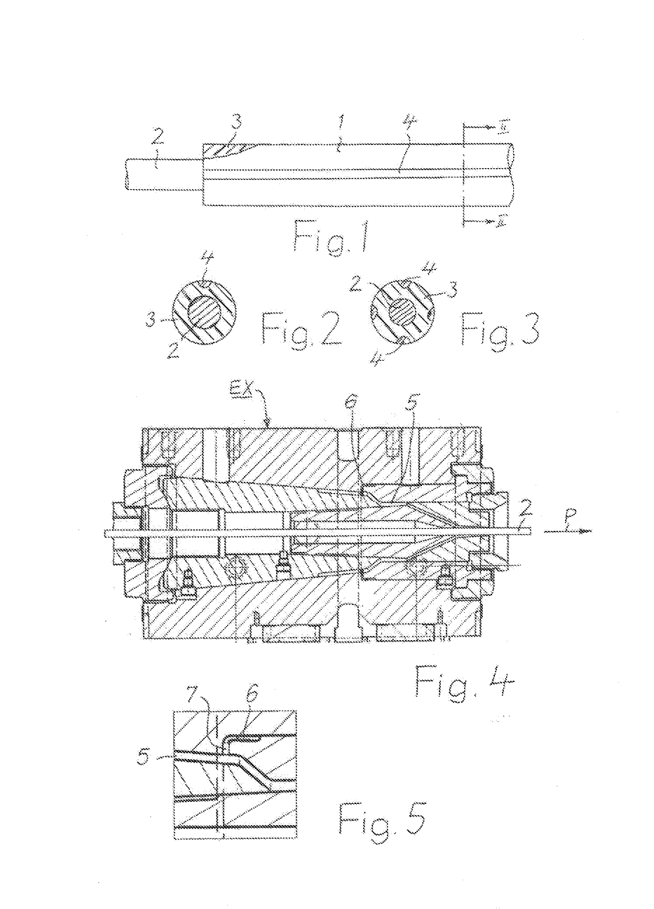

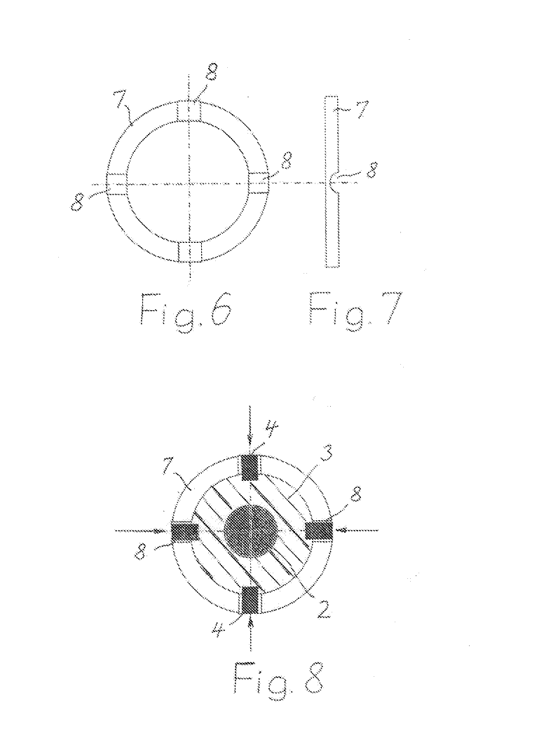

FIG. 2 only illustrates a strip 4. However, the cable 1 can also have more than one strip 4, and indeed according to

FIG. 3 for example, four adjacent strips 4 offset in the circumferential direction of the cable.

An extruder EX schematically depicted in FIG. 4 can, for example, be used to manufacture the cable 1, of which only the necessary parts are illustrated for understanding the invention.

It has an inner flow channel 5 through which the material for the cover 3 is guided and formed around the core 2 of the cable, which is moved through and extruder EX in the direction of the arrow P. The extruder EX also has an outer flow channel 6 through which the material of the strips 4 is guided through, that in co-extrusion impinges on the material of the cover 3. The outer flow channel surrounds the inner flow channel all around. It has, opposite the inner flow channel 5, a smaller inner cross section and leads into a barrier constructed as a ring 7, which surrounds all around the inner flow channel 5. The structure of the ring 7 is shown, for example, in the FIGS. 6 and 7.

The inner diameter Di of the ring 7 corresponds to the outer diameter of the inner flow channel 5. The material of the cover 3 can therefore pass unhindered through the ring 7. In the illustrated embodiment the ring 7 has four adjacent passages 8 offset in the circumferential direction, which serve for the production of four strips 4 and through which the guided material of the strips is pushed through the outer flow channel 6.

The passages 8 extend in the ring 7 in the radial direction and actually over the entire radial width of the ring, so that they, in the radial direction to the ring 7, allow the impinging material of the strips 4 through. The passages 8 are mounted only on one side of the ring 7. The ring 7 is mounted on the side of the passages 8 facing away so that is it is an all-around closed ring. The passages 8 are advantageously attached on the side facing away in the inner flow channel 5 in the flow direction of the material for the cover.

In the operation of the extruder EX the material for the cover 3 is delivered into the flow channel 5. Simultaneously, the material for the strips 4 is delivered into the outer flow channel 6, up to the passages 8 of the ring 7 blocked by the same. The outer flow channel 6 then goes through the passages 8 of the ring 7. The material of the strips 4 is pushed or pressed through the passages 8 and in fact on top of the ring 7 in the radial direction. This is also true for the illustrated arrows in FIG. 8 in the radial direction on the material of the cover 3 and is imprinted into the same in the radial direction. The depth with which the material of the strips 4 penetrates into the material of the cover 3 depends on the amount of pressure applied with which the material of the strips 4 calls for.

1. A method of manufacturing a cable, the cable having
an electrical and/or optical transmission element containing core,
a cover surrounding said transmission element, the cover made from insulation material, and
at least one running strip on the outer side of the cable on its entire length in the axial direction, the running strip being made from insulation material that has a different color than the cover,
the material of the cover and the running strip being applied by means of an extruder through co-extrusion simultaneously on the core of the cable so that the material of the running strip is integrated into the material of the cover,
said method comprising the steps of:
the material of the cover and running strip is applied by means of an extruder, having an inner flow channel and one surrounding all-around outer flow channel which merge,
in the outer flow channel, arranging an all-around existing barrier constructed as a ring, that has at least one passage for the required material for a running strip in the outer flow channel, and
the material of the running strip is, with pressure, forced through the passage and pushed or pressed in the inner flow channel, through which the material for the cover is guided, as a result of which the material of the running strip is imprinted or pressed into the material of the cover and thereby is tightly bound with the same or anchored in the same.

2. The method as claimed in claim 1, further comprising applying a plurality of running strips in said cover.

3. Arrangement with a device for carrying out the method according to claim 1, the arrangement for making the cable having a cover composed of insulation material formed around the core, where the cover has at least one running strip composed of insulation material extending in the axial direction of the cable and that is tightly bound and integrated in the material of the cover, said arrangement comprising:
an extruder with an inner flow channel and an outer flow channel surrounding all around, said inner flow channel and said outer flow channel configured to merge into one another, and
wherein the outer flow channel has a barrier constructed as a ring, the ring having at least one passage through which the guided material in the outer flow channel is led in the radial direction into the flow channel.
